(19) United States
(12) Patent Application Publication
(10) Pub. No.: US 2026/0210420 A1
(43) Pub. Date: Jul. 23, 2026

(54) FRICTION DAMPERS AND FRICTION DAMPING METHODS

(71) Applicant: The Boeing Company, Arlington, VA (US)

(72) Inventors: Richard W. Aston, Steilacoom, WA (US); Trent M. Aston, Steilacoom, WA (US); Daniel L. Mosier, Seattle, WA (US); Mara Pearson, Seattle, WA (US)

(73) Assignee: The Boeing Company, Arlington, VA (US)

(21) Appl. No.: 18/985,325

(22) Filed: Dec. 18, 2024

(51) Int. Cl. F16F 7/02; F16C 11/04; F16F 7/04

(52) U.S. Cl. CPC F16F 7/026; F16C 11/045; F16F 7/04; F16F 2222/04; F16F 2228/066; F16F 2230/04; F16F 2232/02; F16F 2236/08

(57) ABSTRACT

A friction damper includes a central axis, a damper housing, a bearing assembly, and a loading assembly. The damper housing includes a bore extending along the central axis. The bearing assembly is situated in the bore and is configured to rotate in a load direction about the central axis relative to the damper housing in response to a torsional load applied to the bearing assembly. The loading assembly is situated in the bore and is configured to apply an axial load to the bearing assembly along the central axis.

### FIELD

The present disclosure relates generally to load and motion damping and, more particularly, to friction dampers and friction damping methods using friction dampers.

### BACKGROUND

Friction dampers are used to absorb and dissipate energy through friction. They are commonly employed in various mechanical applications to reduce vibrations, absorb energy, improve stability, and enhance durability. However, conventional friction dampers can have various disadvantages. Conventional friction dampers can be overly heavy or unreliable, particularly for aerospace applications. Some types of friction dampers rely on internal fluid that is prone to leaking or that requires use of a heater and thermostat for temperature control. Other types of friction dampers utilize internal gearing that increases complexity, weight, and cost. Accordingly, those skilled in the art continue with research and development efforts in friction dampers and damping methods.

### SUMMARY

Disclosed are examples of a friction damper, a dampened system, and a damping method. The following is a non-exhaustive list of examples, which may or may not be claimed, of the subject matter according to the present disclosure.

In an example, the disclosed friction damper includes a central axis, a damper housing, a bearing assembly, and a loading assembly. The damper housing includes a bore extending along the central axis. The bearing assembly is situated in the bore and is configured to rotate in a load direction about the central axis relative to the damper housing in response to a torsional load applied to the bearing assembly. The loading assembly is situated in the bore and is configured to apply an axial load to the bearing assembly along the central axis.

In an example, the disclosed system includes a platform, a friction damper, and a component. The friction damper includes a central axis, a damper housing, a bearing assembly, and a loading assembly. The damper housing is coupled to the platform and includes a bore extending along the central axis. The bearing assembly is situated in the bore and is configured to rotate in a load direction about the central axis relative to the damper housing in response to a torsional load applied to the bearing assembly. The loading assembly is situated in the bore and is configured to apply an axial load to the bearing assembly along the central axis. The component includes a shaft received by the bore and is configured to apply the torsional load.

In an example, the disclosed method includes steps of: (1) coupling a shaft to a friction damper that includes a central axis, a damper housing including a bore extending along the central axis and configured to receive the shaft, a bearing assembly situated in the bore, and a loading assembly situated in the bore; (2) freely rotating the shaft in free direction about the central axis; (3) rotating the shaft in a load direction about the central axis, opposite the free direction; (4) applying a torsional load to the bearing assembly in response to rotating the shaft in the load direction; (5) applying an axial load to the bearing assembly along the central axis by the loading assembly; and (6) damping rotation of the shaft about the central axis.

Other examples of the friction damper, the system, and the method will become apparent from the following detailed description, the accompanying drawings, and the appended claims.

### BRIEF DESCRIPTION OF THE DRAWINGS

FIG. 1 is a schematic block diagram of an example of a friction damper;

FIG. 2 is a flow diagram of an example of a friction damping method;

FIG. 3 is a schematic, exploded view of an example of the friction damper;

FIG. 4 is a schematic, sectional view of an example of the friction damper;

FIG. 5 is a schematic, sectional view of an example of the friction damper and shaft coupled to the friction damper;

FIG. 6 is a schematic illustration of a system that utilizes the friction damper;

FIG. 7 is a schematic illustration of the system that utilizes the friction damper;

FIG. 8 is a schematic block diagram of an example of an aerospace platform; and

FIG. 9 is a flow diagram of an example of a manufacturing and service method.

### DETAILED DESCRIPTION

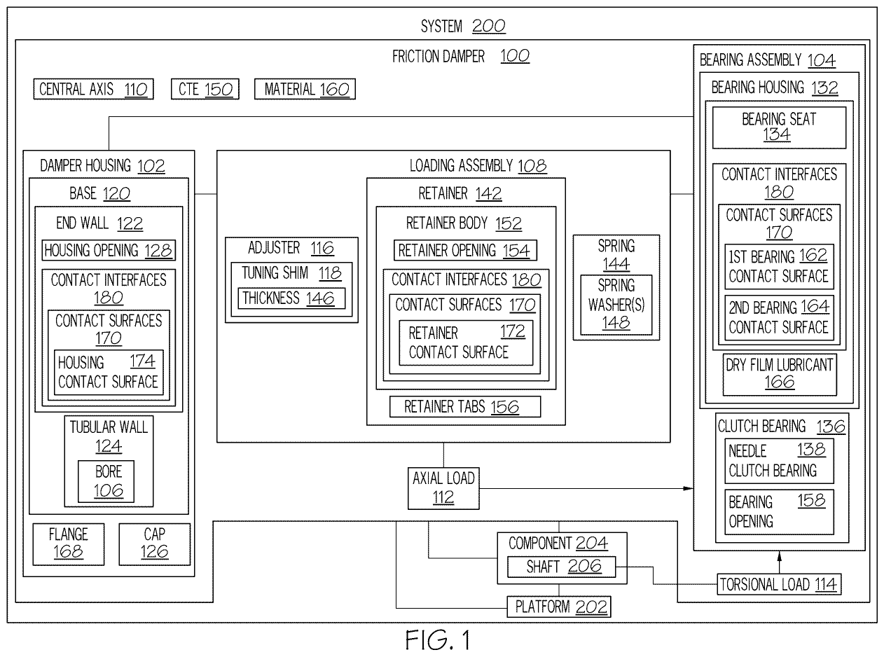

Referring generally to FIG. 1-7, by way of examples, the present disclosure is directed to a friction damper 100, a dampened system 200, and a damping method 1000. In various examples, the friction damper 100 provides an improved solution with various advantages compared to existing friction dampers. In various examples, the friction damper 100 is less complex, less expensive, lower in weight, and more reliable than conventional solutions by not requiring internal fluid or gearing for operation or temperature control. In various examples, operation of the friction damper 100 is resistant to variations in temperature.

In various examples, the friction damper 100 provides resistive damping through friction. Generally, the friction damper 100 uses friction to dissipate energy, reduce vibrations, stabilize mechanical systems, and/or absorb and control unwanted motion. As will be described herein, the friction damper 100 operates on the principle of frictional resistance, in which relative movement between two contact surfaces generates friction, thereby damping the motion. In various examples, the magnitude of friction and, thus, the resistance to motion and damping provided by the friction damper 100 is adjustable or “tunable” for a particular application. In these examples, the friction damper 100 can be preloaded to a desired degree to produce a desired friction and, thus, damping. In various examples, the friction is substantially constant. In these examples, constant friction is achieved using materials having substantially the same coefficients of thermal expansion and/or by using a dry film lubricant between contact surfaces. In such examples, the materials properties may only vary slightly over large temperature variations (e.g., resistant to temperature extremes).

Referring now to FIGS. 1 and 3-7, the following are examples of the friction damper 100, according to the present disclosure. Examples of the friction damper 100 include a number of elements, features, and components. Not all of the elements, features, and/or components described or illustrated in one example are required in that example. Some or all of the elements, features, and/or components described or illustrated in one example can be combined with other examples in various ways without the need to include other elements, features, and/or components described in those other examples, even though such combination or combinations are not explicitly described or illustrated by example herein.

As illustrated in FIGS. 1 and 3-5, in the disclosed examples, the friction damper 100 is a rotational friction damper that utilizes relative rotary motion between contact surfaces to provide controlled resistance. In one or more examples, the friction damper 100 includes a central axis 110, a damper housing 102, a bearing assembly 104, and a loading assembly 108.

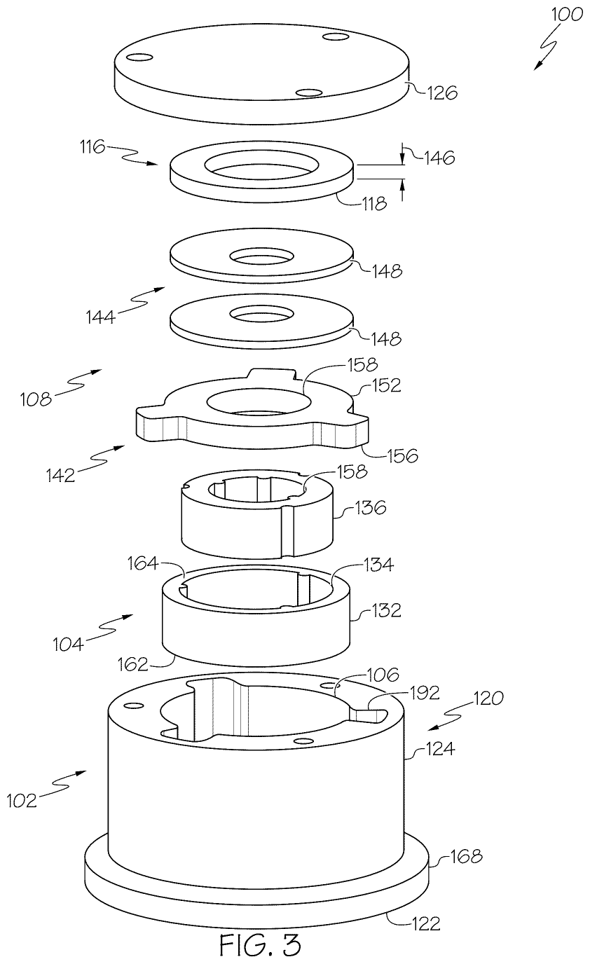

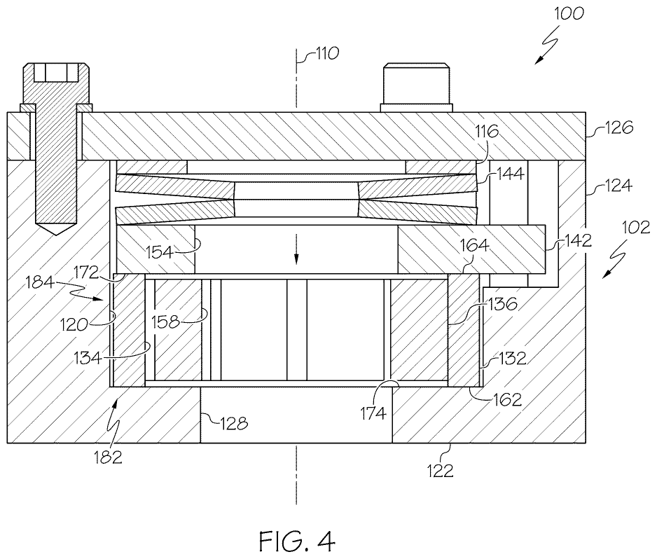

As illustrated in FIGS. 3-5, in one or more examples, the damper housing 102 includes a bore 106 that extends along the central axis 110. The damper housing 102 serves as at least a portion of the structural housing of the friction damper 100 that encases and ensures alignment of the internal components of the friction damper 100. In one or more examples, the damper housing 102 provides at least one of the contact surfaces 170 or contact interfaces 180 that produce the damping friction. As illustrated in FIG. 4, in one or more examples, the damper housing 102 includes a housing contact surface 174 and forms a portion of a housing-to-bearing contact interface 182.

As illustrated in FIGS. 1 and 3-5, in one or more examples, the damper housing 102 includes a base 120 and a cap 126. The base 120 includes an end wall 122 and a tubular wall 124. The tubular wall 124 extends from the end wall 122 along the central axis 110 and forms the bore 106. The cap 126 is coupled to the tubular wall 124 opposite the end wall 122 to enclose the bore 106. In one or more examples, the end wall 122 includes an opening 128 into the bore 106. The opening 128 is configured to receive a portion of a shaft 206 of an associated component 204 (e.g., FIGS. 1, 5 and 7) that engages the friction damper 100 for damping relative rotation of the shaft 206. Generally, the opening 128 is smaller than the bore 106. In one or more examples, the damper housing 102 includes at least one flange 168. The flange 168 extends from the base 120 and is configured for coupling the friction damper 100 to another structure.

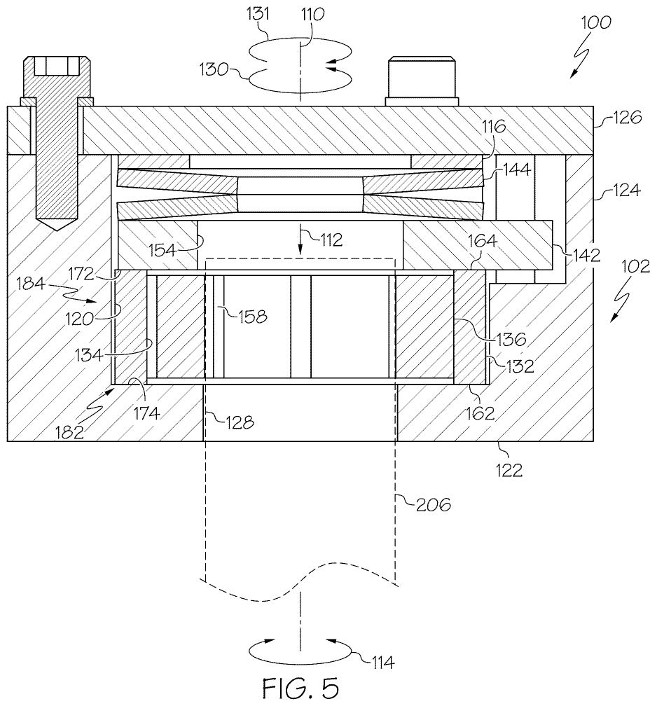

As illustrated in FIGS. 3-5, in one or more examples, the bearing assembly 104 is situated in the bore 106. The bearing assembly 104 is configured to receive and engage a portion of the shaft 206. The bearing assembly 104 is configured to rotate in a load direction 130 (FIG. 5) and a free direction 131 (FIG. 5) about the central axis 110 relative to the damper housing 102 in response to a torsional load 114 (FIGS. 1 and 5) applied to the bearing assembly 104 by rotation of the shaft 206. The bearing assembly 104 resists rotation in the load direction 130 in response to the torsional load 114 applied by the shaft 206 in a first rotational direction due to a friction force created between contact surfaces 170 or at the contact interfaces 180. The bearing assembly 104 enables free or unrestricted rotation in the free direction 131, opposite the load direction 130, in response to the torsional load 114 applied by the shaft 206 in an opposing second rotational direction. In one or more examples, the bearing assembly 104 provides at least one of the contact surfaces 170 or contact interfaces 180 that produce the damping friction. In one or more examples, contact between the damper housing 102 and the bearing assembly 104 produces at least a portion of the damping friction. As illustrated in FIG. 4, in one or more examples, the bearing assembly 104 includes a first bearing contact surface 162 and the end wall 122 of the damper housing 102 includes the housing contact surface 174 that form at least a portion of the housing-to-bearing contact interface 182.

As illustrated in FIGS. 3-5, in one or more examples, the loading assembly 108 is situated in the bore 106 and is configured to apply an axial load 112 (FIGS. 1 and 4) to the bearing assembly 104 along the central axis 110. In these examples, the loading assembly 108 serves as a preload mechanism that applies the axial load 112 (e.g., a pressure or force) to maintain contact between the contact surfaces 170 of the friction damper 100. In one or more examples, the preload provided by the loading assembly 108 is constant. In one or more examples, the loading assembly 108 enables selective adjustment of the preload and, thus, precise selection of the friction generated between the contact surfaces 170. In one or more examples, the loading assembly 108 generates the friction force in response to rotation of the bearing assembly 104 relative to the damper housing 102 by applying the axial load 112 to the bearing assembly 104 and pressing the first bearing contact surface 162 of the bearing assembly 104 against the housing contact surface 174 of the damper housing 102.

As illustrated in FIG. 1, in one or more examples, the loading assembly 108 includes a spring 144. In one or more examples, the spring 144 is positioned in the bore 106 and is in contact with the bearing assembly 104. The spring 144 applies the axial load 112 (FIG. 4) to the bearing assembly 104. In these examples, the axial load 112 is applied along (e.g., parallel to or coincident with) the central axis 110 (e.g., FIGS. 4 and 5).

The spring 144 can include any suitable mechanism that is capable of storing and releasing energy, absorbing shock and/or vibration, and providing resistance to motion. While specific examples of the spring 144 are described herein and illustrated in FIGS. 3-5 and have particular benefits and advantages, other examples of spring mechanisms are contemplated without limitation.

As illustrated in FIGS. 1 and 3-5, in one or more examples, the spring 144 includes or takes the form of at least one spring washer 148. In one or more examples, the spring 144 includes or takes the form of a plurality of spring washers 148. As examples, the spring washers 148 take the form of Belleville washers or similar coned-disc springs or conical spring washers. In one or more examples, the number of the spring washers 148 and/or a rotational orientation (e.g., curvature facing up or curvature facing down along the central axis 110) of at least one of the spring washers 148 relative to another one of the spring washers 148 is configured to adjust the axial load 112 applied to the bearing assembly 104 by the spring 144. As an example, the spring washers 148 can be stacked to increase the axial load 112 applied to the bearing assembly 104. For example, a greater number of the spring washers 148 (e.g., a thicker stack) can produce a greater magnitude of the axial load 112 and, thus, a greater damping friction between contact surfaces 170. As another example, two or more of the spring washers 148 can be rotationally oriented relative to each other such that the curvature of the spring washers 148 face the same direction along the central axis 110 and the spring washers 148 nest with each other. Alternatively, or additionally, as another example, two or more of the spring washers 148 can be rotationally oriented relative to each other such that the curvature of the spring washers 148 face opposite directions along the central axis 110 (e.g., as illustrated in FIGS. 4 and 5).

As illustrated in FIGS. 1 and 3-5, in one or more examples, the loading assembly 108 includes a retainer 142. In these examples, the retainer 142 is positioned in the bore 106 and is in contact with the bearing assembly 104. In these examples, the spring 144 is positioned in the bore 106 and is in contact with the retainer 142 (e.g., between the damper housing 102 and the retainer 142). In these examples, the retainer 142 is situated or positioned between the spring 144 and the bearing assembly 104. In these examples, the spring 144 applies the axial load 112 (FIG. 4) to the bearing assembly 104 via the retainer 142 (e.g., spring 144 applies axial load 112 to retainer 142 and retainer 142 transfers or applies axial load 112 to bearing assembly 104). The axial load 112 is applied along (e.g., parallel to or coincident with) the central axis 110. In one or more examples, the retainer 142 serves as a portion of the structural housing of the friction damper 100 that holds or secures the bearing assembly 104 in the bore 106. In one or more examples, the retainer 142 provides at least one of the contact surfaces 170 or contact interfaces 180 that produce the damping friction. In one or more examples, contact between the retainer 142 and the bearing assembly 104 produces at least a portion of the damping friction. As illustrated in FIG. 4, in one or more examples, the retainer 142 includes a retainer contact surface 172 and the bearing assembly 104 includes a second bearing contact surface 164 that form a retainer-to-bearing contact interface 184.

In one or more examples, the retainer 142 is linearly movable along the central axis 110 relative to the bearing assembly 104. Linear movement of the retainer 142 within the bore 106 along the central axis 110 and relative to the bearing assembly 104 enables the retainer 142 to react in response to the application or adjustment of the axial load 112. Movement of the retainer 142 toward or away from the bearing assembly 104 clamps or compresses the bearing assembly 104 between the retainer 142 and the damper housing 102 for generation of friction at between the contact surfaces 170 of the contact interfaces 180. As an example, the position of the retainer 142 in the bore 106 along the central axis 110 can depend on the configuration of the loading assembly 108 (e.g., the number and/or orientation of the spring washers 148) and/or the adjuster 116 (e.g., a thickness 146 of a tuning shim 118).

In one or more examples, the retainer 142 is rotationally fixed about the central axis 110 relative to the bearing assembly 104. Fixing the rotational position or otherwise preventing rotation of the retainer 142 about the central axis 110 enables friction to be produced for motion damping between the retainer contact surface 172 and the second bearing contact surface 164 during rotation of the bearing assembly 104 in the load direction 130.

As illustrated in FIGS. 1 and 3-5, in one or more examples, the retainer 142 includes a retainer body 152. In one or more examples, the retainer body 152 is disk-shaped. In one or more examples, the retainer body 152 is annular and includes a central retainer opening 154. In these examples, the retainer opening 154 is configured to receive a portion (e.g., an end) of the shaft 206 that extends into the bore 106 and through the bearing assembly 104.

As illustrated in FIGS. 1 and 3-5, in one or more examples, the retainer 142 includes a plurality of retainer tabs 156. In one or more examples, the retainer tabs 156 extend form the retainer body 152. The retainer tabs 156 are configured to engage the damper housing 102. As illustrated in FIG. 3, in one or more examples, the tubular wall 124 of the damper housing 102 includes a plurality of grooves 192. Each one of the grooves 192 is configured to receive one of the retainer tabs 156. With each one of the retainer tabs 156 engaged with (e.g., mated to or received by) a corresponding one of the grooves 192, the retainer 142 is prevented from rotating about the central axis 110.

As illustrated in FIGS. 1 and 3-5, in one or more examples, the loading assembly 108 includes an adjuster 116. The adjuster 116 is situated in the bore 106 and is configured to adjust the axial load 112 applied to the bearing assembly 104 by the loading assembly 108. The adjuster 116 enables selective adjustment of the preload and, thus, precise selection of the friction generated between the contact surfaces 170. In one or more examples, the adjuster 116 facilitates increasing the axial load 112 applied to the bearing assembly 104 by the loading assembly 108, which in turn increases the pressure applied to the contact surfaces 170 between the damper housing 102 and the bearing assembly 104 and, thus, the friction produced for damping motion. Conversely, in one or more examples, the adjuster 116 facilitates decreasing the axial load 112 applied to the bearing assembly 104 by the loading assembly 108, which in turn decreases the pressure applied to the contact surfaces 170 between the damper housing 102 and the bearing assembly 104 and, thus, the friction produced for damping motion. In these examples, the adjuster 116 establishes and provides a predetermined or constant (e.g., prescribed or desired) resistive torque in the load direction 130 in response to application of the torsional load 114 (FIG. 5).

As illustrated in FIGS. 3-5, in one or more examples, the adjuster 116 is positioned in the bore 106 between the spring 144 and the damper housing 102 (e.g., the cap 126). The adjuster 116 is configured to adjust the axial load 112 applied to the bearing assembly 104 by the spring 144. As an example, the adjuster 116 preloads the spring 144 to produce a desired spring compression or spring pre-tensioning and, thus, a desired magnitude for the axial load 112 applied to the bearing assembly 104 by the spring 144.

As illustrated in FIGS. 1 and 3-5, in one or more examples, the adjuster 116 includes a tuning shim 118. The tuning shim 118 is situated in the bore 106 between the damper housing 102 (e.g., cap 126) and the spring 144. The tuning shim 118 has a thickness 146 (FIGS. 1 and 3). Selection of, or selective variations in, the thickness 146 of the tuning shim 118 correspond to selective variations or adjustments in the axial load 112 and, thus, the friction between contact surfaces 170. As an example, a selected thickness 146 of the tuning shim 118 preloads the spring 144 to a predetermined amount in order to produce the desired spring compression or spring pre-tensioning and, thus, the desired magnitude for the axial load 112 applied to the bearing assembly 104 by the spring 144. In one or more examples, the tuning shim 118 is disk-shaped and is configured to sit within the bore 106. In one or more examples, the tuning shim 118 is annular with a center opening centered along the central axis 110. The thickness 146 of the tuning shim 118 can be formed by machining a blank shim to the desired thickness or stacking a number of shim material layers to produce the desired thickness.

As illustrated in FIGS. 1 and 3-5, in one or more examples, the bearing assembly 104 includes a bearing housing 132 and a clutch bearing 136. The bearing housing 132 is positioned in the bore 106 between the loading assembly 108 and the damper housing 102. As an example, the bearing housing 132 is situated between the retainer 142 and the end wall 122 of the damper housing 102. The bearing housing 132 includes a bearing seat 134. The clutch bearing 136 is positioned in the bearing seat 134. The clutch bearing 136 includes a bearing opening 158. The bearing opening 158 is configured to receive an end the shaft 206. The bearing housing 132 is rotatable about the central axis 110 relative to the damper housing 102 (e.g., the end wall 122 and the tubular wall 124). The clutch bearing 136 is rotationally fixed about the central axis 110 relative to the bearing housing 132. In one or more examples, the clutch bearing 136 is press fit into the bearing seat 134 of the bearing housing 132. The clutch bearing 136 is a type of bearing that prevents rotational motion of the shaft 206 in a first direction (e.g., load direction 130) and that allows rotational motion of the shaft 206 in an opposing, second direction (e.g., free direction 131). In one or more examples, the clutch bearing 136 includes a needle clutch bearing 138. As such, the bearing housing 132 is configured to rotate about the central axis 110 in the load direction 130 relative to the damper housing 102 in response to the torsional load 114 applied to the clutch bearing 136 by rotation of the shaft 206 in the load direction 130. The friction force created by relative movement of the contact surfaces 170 under the axial load 112 at the contact interfaces 180 between the bearing housing 132, the damper housing 102, and the retainer 142 dampens the rotational motion of the shaft 206.

As illustrated in FIGS. 1, 4 and 5, in one or more examples, the bearing housing 132 includes or forms the first bearing contact surface 162 and the second bearing contact surface 164. In these examples, the first bearing contact surface 162 is in contact with the damper housing 102 and the second bearing contact surface 164 is in contact with the loading assembly 108. As an example, the first bearing contact surface 162 is in contact with the housing contact surface 174 of the damper housing 102 and forms the housing-to-bearing contact interface 182. The second bearing contact surface 164 is in contact with the retainer contact surface 172 and forms the retainer-to-bearing contact interface 184.

As illustrated in FIG. 1, in one or more examples, the friction damper 100 includes a dry film lubricant 166. The dry film lubricant 166 is applied to one or more of the contact surfaces 170. In one or more examples, the bearing housing 132 includes the dry film lubricant 166 that is applied to at least one of the first bearing contact surface 162 and the second bearing contact surface 164. In other examples, the dry film lubricant 166 can be applied to the housing contact surface 174 and/or the retainer contact surface 172.

As illustrated in FIG. 1, in one or more examples, each one of the components of the friction damper 100 has a coefficient of thermal expansion 150 (“CTE”). As an example, each one of the damper housing 102, the bearing assembly 104, and the loading assembly 108 includes the coefficient of thermal expansion 150 that is substantially the same. The components of the friction damper 100 having substantially the same coefficient of thermal expansion 150 makes the friction damper 100 insensitive to temperature variations. The friction damper 100 having a consistent and compatible coefficient of thermal expansion 150 mitigates the effects of thermal expansion, which can affect friction. However, in other examples, any one or more of the various components of the friction damper 100 can have a different coefficient of thermal expansion 150. Advantageously, the components of the friction damper 100 having substantially the same values for the coefficient of thermal expansion 150 leads to consistent friction over temperature.

As illustrated in FIG. 1, in one or more examples, each one of the components of the friction damper 100 is made of a material 160. As an example, each one of the damper housing 102, the bearing assembly 104, and the loading assembly 108 is made of the material 160 that is substantially the same. The components of the friction damper 100 being made of substantially the same material facilitates substantially the same coefficient of thermal expansion 150 and, thus, makes the friction damper 100 insensitive to temperature variations. As an example, the damper housing 102 (e.g., the base 120, end wall 122, tubular wall 124, and cap 126), the loading assembly 108 (e.g., the retainer 142, the adjuster 116, and the spring 144), and the bearing assembly 104 (e.g., the bearing housing 132 and clutch bearing 136) are made of stainless steel or other suitable metallic alloy. The friction damper 100 being made of a consistent and compatible material 160 mitigates the effects of thermal expansion, which can affect friction. However, in other examples, any one or more of the various components of the friction damper 100 can be made of a different material 160.

Referring now to FIGS. 1 and 3-7, the following are examples of the system 200, according to the present disclosure. Examples of the system 200 include a number of elements, features, and components. Not all of the elements, features, and/or components described or illustrated in one example are required in that example. Some or all of the elements, features, and/or components described or illustrated in one example can be combined with other examples in various ways without the need to include other elements, features, and/or components described in those other examples, even though such combination or combinations are not explicitly described or illustrated by example herein.

As illustrated in FIGS. 1, 6 and 7, in one or more examples, the system 200 includes a platform 202, the friction damper 100, and a component 204. The friction damper 100 includes the central axis 110, the damper housing 102, the bearing assembly 104, and the loading assembly 108. The damper housing 102 is coupled to the platform 202 and includes the bore 106 extending along the central axis 110. The bearing assembly 104 is situated in the bore 106 and is configured to rotate in the load direction 130 about the central axis 110 relative to the damper housing 102 in response to the torsional load 114 applied to the bearing assembly 104. The loading assembly 108 is situated in the bore 106 and is configured to apply the axial load 112 to the bearing assembly 104 along the central axis 110. The component 204 includes a shaft 206 that is received by the bore 106 and is configured to apply the torsional load 114.

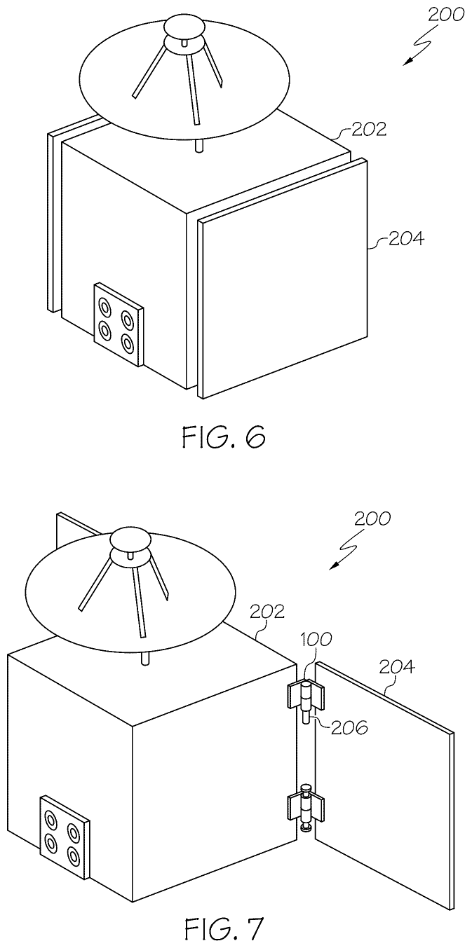

The platform 202 can be any one of various structures or machines. In the examples illustrated in FIGS. 6 and 7, the platform 202 is an aerospace platform or vehicle, such as a satellite. Similarly, the component 204 can be any one of various operational or functional devices used with the platform 202. In the examples illustrated in FIGS. 6 and 7, the component 204 is a solar array of the satellite. In these examples, satellites and other space vehicles with deployable components such as solar arrays typically require performance between approximately −180° C. and approximately +100° C. Such extreme temperature variations can make convention friction dampers unreliable. The disclosed friction damper 100 advantageously provides a fluid free and gear free design, which is insensitive to extreme temperature variations.

As illustrated in FIGS. 6 and 7, in one or more examples, the component 204 is coupled to the platform 202 using one or more of the friction dampers 100. For example, the friction damper 100 can serve as or be integrated with a hinge that enables deployment (FIG. 7) and stowage (FIG. 6) of the component 204. As an example, the friction damper 100 facilitates stowing of the component 204 via pivoting the component 204 and rotating of the shaft 206 in one direction with little friction resistance (e.g., as shown in FIG. 6). The friction damper 100 facilitates motion damping during deployment of the component 204 by providing active, repeatable friction during pivoting the component 204 and rotating of the shaft 206 in the opposing direction (e.g., as shown in FIG. 7).

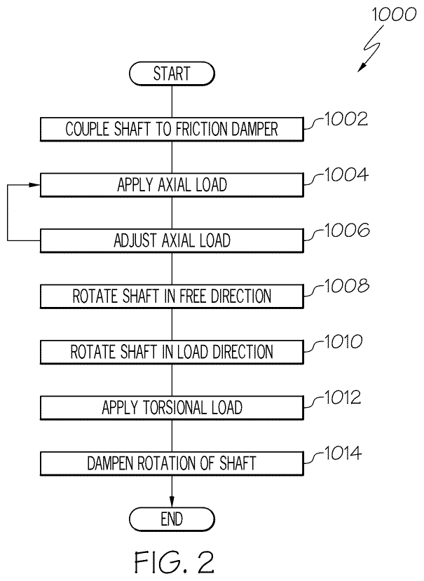

Referring now to FIG. 2, the following are examples of the method 1000, according to the present disclosure. In one or more examples, the method 1000 is implemented using the friction damper 100 and/or the system 200 (FIG. 1). Examples of the method 1000 include a number of elements, steps, operations, or processes. Not all of the elements, steps, operations, or processes described or illustrated in one example are required in that example. Some or all of the elements, steps, operations, or processes described or illustrated in one example can be combined with other examples in various ways without the need to include other elements, steps, operations, or processes described in those other examples, even though such combination or combinations are not explicitly described or illustrated by example herein.

In one or more examples, the method 1000 includes a step of coupling 1002 the shaft 206 to the friction damper 100. The friction damper 100 includes the central axis 110, the damper housing 102, the bearing assembly 104, and the loading assembly 108. The damper housing 102 includes the bore 106 extending along the central axis 110 and is configured to receive the shaft 206. The bearing assembly 104 is situated in the bore 106 and is configured to receive a portion of the shaft 206. The loading assembly 108 is situated in the bore 106.

In one or more examples, the method 1000 includes a step of applying 1004 the axial load 112 to the bearing assembly 104 along the central axis 110 by the loading assembly 108. The loading assembly 108 applies the axial load 112 to the bearing assembly 104 to produce the friction force between contact surfaces 170 during rotation of the bearing assembly 104 relative to the damper housing 102 and the loading assembly 108.

In one or more examples, the method 1000 includes a step of adjusting 1006 the axial load 112 applied to the bearing assembly 104 along the central axis 110 by the loading assembly 108. In one or more examples, the axial load 112 can be adjusted by the configuration of the spring 144 and/or the adjuster 116. Adjusting the axial load 112 facilitates production of a desired friction force between the contact surfaces 170.

In one or more examples, the method 1000 includes a step of freely rotating 1008 the shaft 206 in the free direction 131 about the central axis 110. The bearing assembly 104 is configured to allow free rotation of the shaft 206 about the central axis 110 relative to the bearing assembly 104 in the free direction 131 (FIG. 5). As an example, the clutch bearing 136 allows the shaft 206 to freely rotate (e.g., with negligible friction) in the free direction 131 within the bearing opening 158 relative to the clutch bearing 136.

In one or more examples, the method 1000 includes a step of rotating 1010 the shaft 206 in the load direction 130 about the central axis 110. The load direction 130 is opposite the free direction 131. The bearing assembly 104 is configured to rotate with the shaft 206 when rotating the shaft 206 in the load direction 130 (FIG. 5). As an example, the clutch bearing 136 engages the shaft 206 and prevents free rotation of the shaft 206 within the bearing opening 158 relative to the clutch bearing 136.

In one or more examples, the method 1000 includes a step of applying 1012 the torsional load 114 to the bearing assembly 104 in response to rotating the shaft 206 in the load direction 130. Rotation of the shaft 206 in the load direction 130 applies the torsional load 114 to the clutch bearing 136, which in turn rotates the clutch bearing 136 and the bearing housing 132 coupled to the clutch bearing 136 about the central axis 110 in the load direction 130. The friction force produced between contact surfaces 170 due to the axial load 112 applied to by the loading assembly 108 dampens relative motion of the bearing assembly 104 relative to the damper housing 102 and the loading assembly 108.

In one or more examples, the method 1000 includes a step of damping 1014 rotation of the shaft 206 about the central axis 110. Rotational movement of the shaft 206 relative to the friction damper 100 is dampened due to the frictional resistance provided by relative motion of the contact surfaces 170.

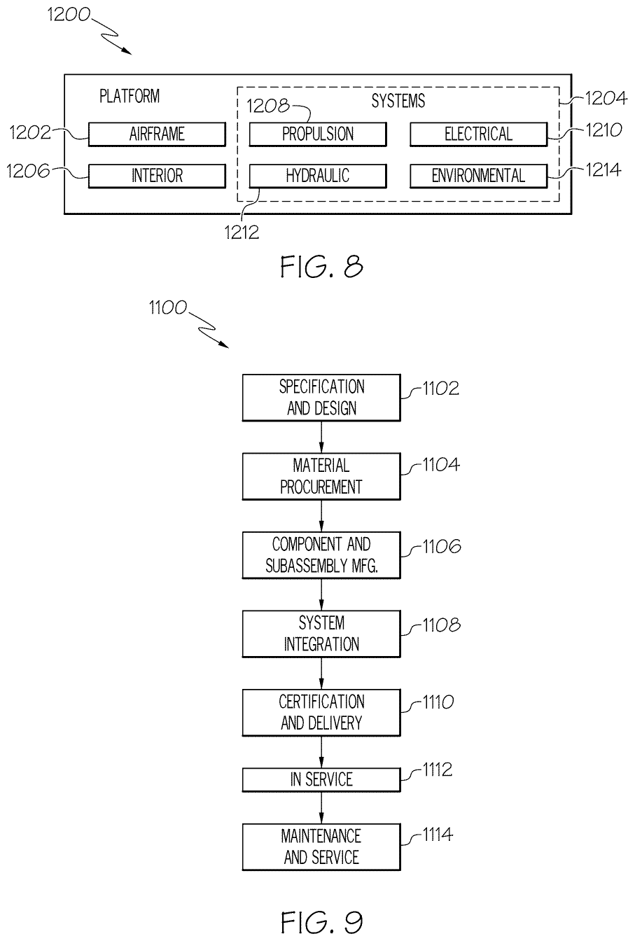

Referring now to FIGS. 8 and 9, examples of the friction damper 100, the system 200, and the method 1000, described herein, may be related to, or used in the context of an aerospace platform 1200, as schematically illustrated in FIG. 8, and an aerospace manufacturing and service method 1100, as shown in the flow diagram of FIG. 9. As an example, the aerospace platform 1200 and/or the manufacturing and service method 1100 may include dampened systems that utilize friction dampers.

Referring to FIG. 8, which illustrates an example of the aerospace platform 1200. The aerospace platform 1200 can be any aerospace vehicle or platform. The aerospace platform 1200 is an example of the platform 202 (e.g., satellite) illustrated in FIGS. 6 and 7. In one or more examples, the aerospace platform 1200 includes the airframe 1202 having the interior 1206. The aerospace platform 1200 includes a plurality of onboard systems 1204 (e.g., high-level systems). Examples of the onboard systems 1204 of the aerospace platform 1200 include propulsion systems 1208, hydraulic systems 1212, electrical systems 1210, and environmental systems 1214. In other examples, the onboard systems 1204 also includes one or more control systems coupled to the airframe 1202 of the aerospace platform 1200. In yet other examples, the onboard systems 1204 also include one or more other systems, such as, but not limited to, communications systems, avionics systems, software distribution systems, network communications systems, passenger information/entertainment systems, guidance systems, radar systems, weapons systems, and the like. The aerospace platform 1200 can have any number of components that are coupled together and dampened using the friction damper 100 and/or according to the method 1000.

Referring to FIG. 9, during pre-production of the aerospace platform 1200, the manufacturing and service method 1100 includes specification and design 1102 of the aerospace platform 1200 and material procurement 1104. During production of the aerospace platform 1200, component and subassembly manufacturing 1106 and system integration 1108 of the aerospace platform 1200 take place. Thereafter, the aerospace platform 1200 goes through certification and delivery 1110 to be placed in service 1112. Routine maintenance and service 1114 includes modification, reconfiguration, refurbishment, etc. of one or more systems of the aerospace platform 1200.

Each of the processes of the manufacturing and service method 1100 illustrated in FIG. 9 may be performed or carried out by a system integrator, a third party, and/or an operator (e.g., a customer). For the purposes of this description, a system integrator may include, without limitation, any number of aircraft manufacturers and major-system subcontractors; a third party may include, without limitation, any number of vendors, subcontractors, and suppliers; and an operator may be an airline, leasing company, military entity, service organization, and so on.

Examples of the friction damper 100, the system 200, and the method 1000, shown and described herein, may be employed during any one or more of the stages of the manufacturing and service method 1100 shown in the flow diagram illustrated by FIG. 9. In an example, components of the aerospace platform 1200 can be installed and relative movement of such components can be dampened using the friction damper 100 and/or according to the method 1000 during a portion of component and subassembly manufacturing 1106 and/or system integration 1108. Further, components of the aerospace platform 1200 can be installed and relative movement of such components can be dampened using the friction damper 100 and/or according to the method 1000 while the aerospace platform 1200 is in service 1112. Also, components of the aerospace platform 1200 can be installed and relative movement of such components can be dampened using the friction damper 100 and/or according to the method 1000 during system integration 1108 and certification and delivery 1110. Similarly, components of the aerospace platform 1200 can be installed and relative movement of such components can be dampened using the friction damper 100 and/or according to the method 1000 while the aerospace platform 1200 is in service 1112 and during maintenance and service 1114.

The preceding detailed description refers to the accompanying drawings, which illustrate specific examples described by the present disclosure. Other examples having different structures and operations do not depart from the scope of the present disclosure. Like reference numerals may refer to the same feature, element, or component in the different drawings. Throughout the present disclosure, any one of a plurality of items may be referred to individually as the item and a plurality of items may be referred to collectively as the items and may be referred to with like reference numerals. Moreover, as used herein, a feature, element, component, or step preceded with the word “a” or “an” should be understood as not excluding a plurality of features, elements, components, or steps, unless such exclusion is explicitly recited.

Illustrative, non-exhaustive examples, which may be, but are not necessarily, claimed, of the subject matter according to the present disclosure are provided above. Reference herein to “example” means that one or more feature, structure, element, component, characteristic, and/or operational step described in connection with the example is included in at least one aspect, embodiment, and/or implementation of the subject matter according to the present disclosure. Thus, the phrases “an example,” “another example,” “one or more examples,” and similar language throughout the present disclosure may, but do not necessarily, refer to the same example. Further, the subject matter characterizing any one example may, but does not necessarily, include the subject matter characterizing any other example. Moreover, the subject matter characterizing any one example may be, but is not necessarily, combined with the subject matter characterizing any other example.

As used herein, a system, apparatus, device, structure, article, element, component, or hardware “configured to” perform a specified function is indeed capable of performing the specified function without any alteration, rather than merely having potential to perform the specified function after further modification. In other words, the system, apparatus, device, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware that enable the system, apparatus, structure, article, element, component, or hardware to perform the specified function without further modification. For purposes of this disclosure, a system, apparatus, device, structure, article, element, component, or hardware described as being “configured to” perform a particular function may additionally or alternatively be described as being “adapted to” and/or as being “operative to” perform that function.

Unless otherwise indicated, the terms “first,” “second,” “third,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, the phrase “at least one of,” when used with a list of items, means different combinations of one or more of the listed items may be used and only one of each item in the list may be needed. For example, “at least one of item A, item B, and item C” may include, without limitation, item A or item A and item B. This example also may include item A, item B, and item C, or item B and item C. In other examples, “at least one of” may be, for example, without limitation, two of item A, one of item B, and ten of item C; four of item B and seven of item C; and other suitable combinations. As used herein, the term “and/or” and the “/” symbol includes any and all combinations of one or more of the associated listed items.

For the purpose of this disclosure, the terms “coupled,” “coupling,” and similar terms refer to two or more elements that are joined, linked, fastened, attached, connected, put in communication, or otherwise associated (e.g., mechanically, electrically, fluidly, optically, electromagnetically) with one another. In various examples, the elements may be associated directly or indirectly. As an example, element A may be directly associated with element B. As another example, element A may be indirectly associated with element B, for example, via another element C. It will be understood that not all associations among the various disclosed elements are necessarily represented. Accordingly, couplings other than those depicted in the figures may also exist.

As used herein, the term “approximately” refers to or represents a condition that is close to, but not exactly, the stated condition that still performs the desired function or achieves the desired result. As an example, the term “approximately” refers to a condition that is within an acceptable predetermined tolerance or accuracy, such as to a condition that is within 10% of the stated condition. However, the term “approximately” does not exclude a condition that is exactly the stated condition. As used herein, the term “substantially” refers to a condition that is essentially the stated condition that performs the desired function or achieves the desired result.

FIGS. 1 and 3-8, referred to above, may represent functional elements, features, or components thereof and do not necessarily imply any particular structure. Accordingly, modifications, additions and/or omissions may be made to the illustrated structure. Additionally, those skilled in the art will appreciate that not all elements, features, and/or components described and illustrated in FIGS. 1 and 3-8, referred to above, need be included in every example and not all elements, features, and/or components described herein are necessarily depicted in each illustrative example. Accordingly, some of the elements, features, and/or components described and illustrated in FIGS. 1 and 3-8 may be combined in various ways without the need to include other features described and illustrated in FIGS. 1 and 3-8, other drawing figures, and/or the accompanying disclosure, even though such combination or combinations are not explicitly illustrated herein. Similarly, additional features not limited to the examples presented, may be combined with some or all of the features shown and described herein. Unless otherwise explicitly stated, the schematic illustrations of the examples depicted in FIGS. 1 and 3-8, referred to above, are not meant to imply structural limitations with respect to the illustrative example. Rather, although one illustrative structure is indicated, it is to be understood that the structure may be modified when appropriate. Accordingly, modifications, additions and/or omissions may be made to the illustrated structure. Furthermore, elements, features, and/or components that serve a similar, or at least substantially similar, purpose are labeled with like numbers in each of FIGS. 1 and 3-8, and such elements, features, and/or components may not be discussed in detail herein with reference to each of FIGS. 1 and 3-8. Similarly, all elements, features, and/or components may not be labeled in each of FIGS. 1 and 3-8, but reference numerals associated therewith may be utilized herein for consistency.

In FIGS. 2 and 9, referred to above, the blocks may represent operations, steps, and/or portions thereof and lines connecting the various blocks do not imply any particular order or dependency of the operations or portions thereof. It will be understood that not all dependencies among the various disclosed operations are necessarily represented. FIGS. 2 and 9 and the accompanying disclosure describing the operations of the disclosed methods set forth herein should not be interpreted as necessarily determining a sequence in which the operations are to be performed. Rather, although one illustrative order is indicated, it is to be understood that the sequence of the operations may be modified when appropriate. Accordingly, modifications, additions and/or omissions may be made to the operations illustrated and certain operations may be performed in a different order or simultaneously. Additionally, those skilled in the art will appreciate that not all operations described need to be performed.

Further, references throughout the present specification to features, advantages, or similar language used herein do not imply that all of the features and advantages that may be realized with the examples disclosed herein should be, or are in, any single example. Rather, language referring to the features and advantages is understood to mean that a specific feature, advantage, or characteristic described in connection with an example is included in at least one example. Thus, discussion of features, advantages, and similar language used throughout the present disclosure may, but does not necessarily, refer to the same example.

The described features, advantages, and characteristics of one example may be combined in any suitable manner in one or more other examples. One skilled in the relevant art will recognize that the examples described herein may be practiced without one or more of the specific features or advantages of a particular example. In other instances, additional features and advantages may be recognized in certain examples that may not be present in all examples. Furthermore, although various examples of the friction damper 100, the system 200, and the method 1000 have been shown and described, modifications may occur to those skilled in the art upon reading the specification. The present application includes such modifications and is limited only by the scope of the claims.

What is claimed is:

1. A friction damper comprising:
a central axis;
a damper housing comprising a bore extending along the central axis;
a bearing assembly situated in the bore and configured to rotate in a load direction about the central axis relative to the damper housing in response to a torsional load applied to the bearing assembly; and
a loading assembly situated in the bore and configured to apply an axial load to the bearing assembly along the central axis.

2. The friction damper of claim 1, wherein the loading assembly comprises an adjuster situated in the bore and configured to adjust the axial load applied to the bearing assembly by the loading assembly.

3. The friction damper of claim 1, wherein:
the loading assembly comprises:
a retainer positioned in the bore and in contact with the bearing assembly; and
a spring positioned in the bore and in contact with the retainer;
the spring applies the axial load to the retainer; and
the retainer transfers the axial load to the bearing assembly.

4. The friction damper of claim 3, wherein:
the loading assembly further comprises an adjuster positioned in the bore between the spring and the damper housing; and
the adjuster is configured to adjust the axial load applied to the bearing assembly by the spring.

5. The friction damper of claim 4, wherein:
the adjuster comprises a tuning shim having a thickness; and
variations in the thickness of the tuning shim correspond to variations in the axial load.

6. The friction damper of claim 3, wherein the spring comprises at least one spring washer.

7. The friction damper of claim 3, wherein the spring comprises a plurality of spring washers.

8. The friction damper of claim 7, wherein a number of the spring washers and a rotational orientation of at least one of the spring washers relative to another one of the spring washers is configured to adjust the axial load applied to the bearing assembly by the spring.

9. The friction damper of claim 3, wherein the retainer is linearly movable along the central axis relative to the bearing assembly and is rotationally fixed about the central axis relative to the bearing assembly.

10. The friction damper of claim 9, wherein the retainer comprises:
a retainer body comprising a retainer opening; and
a plurality of retainer tabs extending form the retainer body and configured to engage the damper housing.

11. The friction damper of claim 1, wherein:
the bearing assembly comprises:
a bearing housing positioned in the bore between the loading assembly and the damper housing and comprising a bearing seat;
a clutch bearing positioned in the bearing seat and comprising a bearing opening;
the clutch bearing is fixed relative to the bearing housing; and
the bearing housing is configured to rotate about the central axis in the load direction relative to the damper housing in response to the torsional load applied to the clutch bearing.

12. The friction bearing of claim 11, wherein the clutch bearing comprises a needle clutch bearing.

13. The friction damper of claim 11, wherein the bearing housing comprises:
a first bearing contact surface in contact with the damper housing;
a second bearing contact surface in contact with the loading assembly; and
a dry film lubricant applied to the first bearing contact surface and the second bearing contact surface.

14. The friction damper of claim 1, wherein the damper housing comprises:
a base comprising an end wall and a tubular wall extending from the end wall along the central axis and forming the bore; and
a cap coupled to the tubular wall opposite the end wall.

15. The friction damper of claim 14, wherein:
the end wall comprises an opening into the bore; and
the opening is smaller than the bore.

16. The friction damper of claim 1, wherein the damper housing, the bearing assembly, and the loading assembly comprise a coefficient of thermal expansion that is substantially the same.

17. The friction damper of claim 1, wherein:
the damper housing comprises:
a base comprising:
an end wall comprising an opening into the bore; and
a tubular wall extending from the end wall along the central axis and forming the bore; and
a cap coupled to the tubular wall opposite the end wall;
the bearing assembly comprises:
a bearing housing positioned in the bore and comprising:
a bearing seat;
a first bearing contact surface in contact with the end wall;
a second bearing contact surface opposite the first bearing contact surface; and
a dry film lubricant applied to the first bearing contact surface and the second bearing contact surface; and
a clutch bearing positioned in the bearing seat and comprising a bearing opening; and
the loading assembly comprises:
a retainer positioned in the bore and in contact with the second bearing contact surface of the bearing housing; and
a spring positioned in the bore between the cap and the retainer.

18. A system comprising:
a platform;
a friction damper comprising:
a central axis;
a damper housing coupled to the platform and comprising a bore extending along the central axis;
a bearing assembly situated in the bore and configured to rotate in a load direction about the central axis relative to the damper housing in response to a torsional load applied to the bearing assembly; and
a loading assembly situated in the bore and configured to apply an axial load to the bearing assembly along the central axis; and
a component comprising a shaft received by the bore and configured to apply the torsional load.

19. A friction damping method comprising:
coupling a shaft to a friction damper comprising:
a central axis;
a damper housing comprising a bore extending along the central axis and configured to receive the shaft;
a bearing assembly situated in the bore; and
a loading assembly situated in the bore;
freely rotating the shaft in free direction about the central axis;
rotating the shaft in a load direction about the central axis, opposite the free direction;
applying a torsional load to the bearing assembly in response to rotating the shaft in the load direction;
applying an axial load to the bearing assembly along the central axis by the loading assembly; and
damping rotation of the shaft about the central axis.

20. The friction damping method of claim 19, further comprising adjusting the axial load applied to the bearing assembly along the central axis by the loading assembly.
